(19) United States
(12) Patent Application Publication
(10) Pub. No.: US 2005/0252526 A1
(43) Pub. Date: Nov. 17, 2005

(54) Single wafer cleaning apparatus and cleaning method thereof

(75) Inventors: Naoki Ogawa, Kanagawa (JP); Hayato Iwamoto, Kanagawa (JP); Kazumi Asada, Kanagawa (JP); Mari Yokota, Nagasaki (JP); Yasuhiro Hiei, Kumamoto (JP); Tsuyoshi Nishimatsu, Kumamoto (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/116,353

(22) Filed: Apr. 28, 2005

(30) Foreign Application Priority Data
May 12, 2004 (JP) 2004-142533

(51) Int. Cl. B08B 3/12

(52) U.S. Cl. 134/2; 134/26; 134/149; 134/157; 134/148; 134/151; 134/94.1

(57) ABSTRACT

A single wafer cleaning method and a cleaning apparatus thereof are provided in which the transition to rinse treatment is swiftly performed without being influenced by a chemical liquid component, and a polymer and a residue of chemical liquid are suppressed to reduce defects on a substrate.

The single wafer cleaning method according to an embodiment of the present invention is a single wafer cleaning method of performing cleaning by a chemical liquid 8 and a rinse liquid 14 while rotating a substrate-to-be-cleaned 30, in which after chemical liquid treatment is performed by moving a chemical liquid nozzle 10 over the substrate-to-be-cleaned 30, rinse treatment is performed on the substrate-to-be-cleaned 30 by discharging the rinse liquid 14 from a rinse nozzle 16 disposed fixedly at a position not interfering with the movement of the chemical liquid nozzle 10.

### CROSS REFERENCES TO RELATED APPLICATIONS

The present invention contains subject matter related to Japanese Patent Application JP 2004-142533 filed in the Japanese Patent Office on May 12, 2004, the entire contents of which being incorporated herein by reference.

### BACKGROUND OF THE INVENTION

1. Field of the Invention

The present invention relates to a single wafer cleaning method for cleaning a substrate and a single wafer cleaning apparatus used to implement the method.

2. Description of the Related Art

With the miniaturization of an LSI (large-scale semiconductor integrated circuit) for example, high-speed operation and a reduction in power consumption of an element has been in progress. When forming wiring of the LSI, copper (Cu) has been used for the wiring, and further a material generally called a Low-k film which is a low dielectric constant material has been studied as the material of an insulation film between the wirings in order to reduce a wiring resistance and to secure a wiring capacity. Further, a reduction in dielectric constant of the Low-k film has been in progress in recent years and development of porous materials has been accelerated.

In general, when wiring is formed using copper, a wiring-shaped groove is formed in the Low-k film by a Damascene method, and after a barrier metal and a copper plating layer are buried in the wiring-shaped groove, an extra copper plating layer on the surface is removed by CMP (Chemical Mechanical Polishing).

A processing residue (hereinafter, referred to as a polymer) is generated in a dry etching process when forming the wiring groove. Cleaning treatment is performed in order to remove the polymer. In recent years, single wafer cleaning has been widely performed in the process of cleaning treatment, and removal of the polymer is performed such that an organic-based chemical liquid containing an additive such as an organic solvent or an organic acid is used as a chemical liquid to peel off the polymer on a substrate and the chemical liquid is discharged on the rotating silicon substrate. Subsequently, in general, a process of rinse treatment is performed using a rinse liquid (including pure water) to remove a chemical liquid component remaining on the silicon substrate, and the substrate is dried by way of shaking off through spinning and is sent to a next operation process. As a cleaning apparatus of this kind, a single wafer cleaning apparatus for the purpose of removing a polymer or the like has been proposed as described in Patent reference 1, for example.

FIG. 1 is a schematic sectional diagram of a typical single wafer cleaning apparatus in related art, and FIG. 2 is a plan view of a relevant part thereof. In a chamber 131, a single wafer cleaning apparatus 101 includes substrate holding means 105 to hold a substrate which should be cleaned, specifically a substrate-to-be-cleaned that is a silicon semiconductor substrate 130 in this example, chemical liquid supply means 112 having a chemical liquid nozzle to discharge a chemical liquid 108, and rinse liquid supply means 118 having a rinse nozzle 116 to discharge a rinse liquid 114. The substrate holding means 105 is configured to have a vacuum chuck 106 for holding the semiconductor substrate 130 by vacuum adsorption and to rotatably operate by a motor 107. The chemical liquid supply means 112 is configured to have a chemical liquid nozzle 110 provided on a tip of an arm 111 which can be turned by a motor 113 in a plane parallel with a semiconductor substrate plane. The rinse liquid supply means 118 is disposed at a position opposed to the chemical liquid supply means 112 across the semiconductor substrate 130 and is configured to have the rinse nozzle 116 provided on a tip of an arm 117 which can be turned by a motor 119 in a plane parallel with the semiconductor substrate plane.

As shown in FIG. 2, the chemical liquid nozzle 110 is made to move along a trajectory “a” shown with a broken line by the arm 111 which turns between a central part of the semiconductor substrate 130 and a standby position outside the semiconductor substrate 130. Similarly to the chemical liquid nozzle 110, the rinse liquid nozzle 116 is made to move along a trajectory “b” shown with a solid line in FIG. 2 by the arm 117 which turns between the central part of the semiconductor substrate 130 and a standby position outside the semiconductor substrate 130. Further, the rinse nozzle 116 together with the arm 117 are made movable in the vertical direction so as not to interfere with the chemical liquid nozzle 110.

A cup 120 is disposed in the substrate holding means 105 in order to receive a drainage of the chemical liquid and the rinse liquid at the time of cleaning, and the drainage can be drawn off to a drain 124 from a drainage outlet 121 through a drainage valve 122. The chamber 131 is provided with a carrying in/out entrance 102 for the semiconductor substrate 130, which is capable of opening and closing. The chemical liquid 108 is supplied to the chemical liquid nozzle 110 through a chemical liquid valve 109. The rinse liquid 114 is supplied to the rinse nozzle 116 through a rinse liquid valve 115.

When the semiconductor substrate 130 is cleaned using this single wafer cleaning apparatus 101, the substrate-to-be-cleaned 130 to which cleaning treatment is applied is carried into the chamber 131 from the carrying in/out entrance 102, and the substrate 130 is held by the vacuum chuck 106 of the substrate holding means 105. In a state in which the semiconductor substrate 130 is rotated by the motor 107, the arm 111 of the chemical liquid supply means 112 is turned to move the chemical liquid nozzle 110 from the standby position to the central part of the semiconductor substrate 130 and the chemical liquid 108 is discharged from the chemical liquid nozzle 110 to peel off the polymer on the semiconductor substrate 130. Subsequently, the arm 111 is moved to return the chemical liquid nozzle 110 to the standby position. Then, the arm 117 of the rinse liquid supply means 118 is turned to move the rinse nozzle 116 from the standby position to the central part of the semiconductor substrate 130 and further the arm 117 is descended to move the rinse nozzle 116 to a desired position over the semiconductor substrate 130. At that position, the rinse liquid 114 which is, for example, pure water is discharged on the semiconductor substrate 130 from the rinse nozzle 116 to perform rinse treatment. After the rinse treatment is completed, the arm 117 is raised and is turned to return the rinse nozzle 116 to the standby position. Thus, the cleaning of the semiconductor substrate 130 is completed.

[Patent reference 1] Published Japanese Patent Application No. 2003-234341

However, when shifting from the process of the chemical liquid treatment to the process of the rinse liquid treatment, it takes four seconds after completing the discharge of the chemical liquid before the chemical liquid nozzle 110 reaches the standby position from the central part of the semiconductor substrate 130, and it takes further four seconds before the rinse nozzle 116 reaches to the central part of the semiconductor substrate 130 from the standby position, which means that a standby state of eight seconds in total is needed after completing the discharge of the chemical liquid 108 and before starting the discharge of the rinse liquid 114. Since there is a limitation in transition time to avoid the mutual interference between respective nozzles 110 and 116, the additives such as the organic solvent and the organic acid which are chemical liquid components evaporate during the transition time of treatment and therefore the polymer at the time of dry etching remains on the semiconductor substrate 130 without being removed. Further, when the transition time from the chemical liquid treatment to the rinse treatment becomes long, the chemical liquid 108 is dried on the semiconductor substrate 130 and it is difficult to remove the chemical liquid components even at the process of the rinse treatment, which causes generation of a chemical liquid residue. Due to those problems, there are a possibility of unfavorable influence on characteristics of a semiconductor element formed on the semiconductor substrate and a possibility of decreasing yield ratio.

### SUMMARY OF THE INVENTION

The present invention addresses the above-identified, and other problems associated with conventional methods and apparatuses and provides a single wafer cleaning method and a cleaning apparatus thereof in which transition to rinse treatment is quickly performed without being influenced by a chemical liquid component, so that a residue of a polymer and chemical liquid is restrained to decrease defects occurring on a substrate.

The single wafer cleaning method according to an embodiment of the present invention is a single wafer cleaning method in which a substrate-to-be-cleaned is cleaned by a chemical liquid and a rinse liquid while being rotated, comprising the steps of: performing chemical liquid treatment by moving a chemical liquid nozzle over the substrate-to-be-cleaned, and subsequently performing rinse treatment on the substrate-to-be-cleaned by discharging the rinse liquid from a rinse nozzle fixedly disposed at a position not interfering with the movement of the chemical liquid nozzle.

It is preferable that a plurality of the above-described rinse nozzles are provided and rinse treatment is performed such that the rinse liquid from at least one rinse nozzle among the plurality of rinse nozzles is discharged to a central part of the substrate-to-be-cleaned and the rinse liquid from the other rinse nozzles is discharged to a middle part in a radial direction of the substrate-to-be-cleaned. Further, it is preferable that a time T before shifting to the rinse treatment after the chemical liquid treatment on the substrate-to-be-cleaned is made to be 0.5 sec . T . 1.5 sec. Furthermore, it is preferable that a discharge flow rate M of the rinse liquid discharged from the rinse nozzle is made to be 400 ml/min≦M≦1,000 ml/min. It is preferable that a rotational speed N of the substrate-to-be-cleaned is made to be 150 rpm≦N≦1,000 rpm. It is preferable that pure water or 2-propanol is used as the rinse liquid.

The single wafer cleaning apparatus according to an embodiment of the present invention is a single wafer cleaning apparatus in which a substrate-to-be-cleaned is cleaned by a chemical liquid and a rinse liquid while being rotated, including a substrate holding means which holds and rotates the substrate-to-be-cleaned, a chemical liquid nozzle which moves between a standby position and a central part over the substrate to-be-cleaned, and a rinse nozzle disposed fixedly at a position not interfering with the movement of the chemical liquid nozzle.

It is preferable that a plurality of the above-described rinse nozzles are provided, at least one rinse liquid nozzle among the plurality of rinse nozzles is disposed toward the central part of the substrate-to-be-cleaned and the other rinse nozzles are disposed toward the middle part in the radial direction of the substrate-to-be-cleaned. In addition, it is preferable that the time T before shifting to the rinse treatment after the chemical liquid treatment on the substrate-to-be-cleaned is 0.5 sec≦T≦1.5 sec. It is preferable that the discharge flow rate M of the rinse liquid discharged from the rinse nozzle is 400 ml/min≦M≦1,000 ml/min. It is preferable that the rotational speed N of the substrate-to-be-cleaned is 150 rpm≦N≦1,000 rpm. It is preferable that pure water or 2-propanol is used as the rinse liquid.

In the single wafer cleaning method according to an embodiment of the present invention, since the rinse treatment is performed on the substrate-to-be-cleaned by discharging the rinse liquid from the rinse nozzle disposed fixedly at a position not interfering with the movement of the chemical liquid nozzle after the chemical liquid treatment is performed by moving the chemical liquid nozzle over the substrate-to-be-cleaned, a period of time before starting the discharge of the rinse liquid after finishing the discharge of the chemical liquid can be shortened. Accordingly, the volatilization of the chemical liquid component can be suppressed and the organic residue on the substrate-to-be-cleaned can be removed. In addition, since the transition time is shortened, a propagation of a defect due to the chemical liquid residue can be prevented.

In the single wafer cleaning apparatus according to an embodiment of the present invention, since the rinse nozzle is provided fixedly at a position not interfering with the movement of the chemical liquid nozzle, a period of time before starting the discharge of the rinse liquid after finishing the discharge of the chemical liquid can be shortened. With the reduction of the transition time from the chemical liquid treatment to the rinse treatment, the volatilization of the chemical liquid component can be suppressed and the organic residue on the substrate-to-be-cleaned can be favorably removed and in addition, the propagation of the defect due to the chemical liquid residue can be prevented.

According to an embodiment of the single wafer cleaning method of the present invention, since the cleaning of the substrate-to-be-cleaned can be performed reliably, a yield ratio of the substrate cleaning and further a yield ratio of a product manufactured using this substrate can be improved. Furthermore, the reliability of the substrate cleaning can be improved.

The plurality of rinse nozzles are provided, the rinse liquid from at least one rinse nozzle is discharged toward the central part of the substrate-to-be-cleaned and the rinse liquid from the other rinse nozzles is discharged toward the middle part in the radial direction of the substrate-to-be-cleaned, so that the rinse liquid can be supplied uniformly over the whole surface of the substrate-to-be-cleaned.

The time T before shifting to the rinse treatment after the chemical liquid treatment on the substrate-to-be-cleaned is made to be 0.5 sec to 1.5 sec, so that the transition time is greatly reduced and the cleaning can be performed favorably.

The discharge flow rate M of the rinse liquid discharged from the rinse nozzle is made to be 400 ml/min to 1,000 ml/min, so that the number of the organic residues (the number of defects) can be reduced.

The rotational speed N of the substrate-to-be-cleaned is made to be 150 rpm to 1,000 rpm, so that the number of the organic residues (the number of defects) can be reduced.

Pure water or 2-propanol is used as the rinse liquid, so that the rinse treatment can be performed favorably.

According to an embodiment of the single wafer cleaning apparatus of the present invention, the cleaning treatment of the substrate-to-be-cleaned can be performed reliably. Hence, the yield ratio and the reliability of the substrate cleaning can be improved.

The plurality of rinse nozzles are provided, at least one rinse nozzle is disposed toward the central part of the substrate-to-be-cleaned and the other rinse nozzles are disposed toward the middle part in the radial direction of the substrate-to-be-cleaned, so that the rinse liquid can be supplied uniformly over the whole surface of the substrate-to-be-cleaned and the rinse treatment can be performed favorably.

The time T before shifting to the rinse treatment after the chemical liquid treatment on the substrate-to-be-cleaned is set to 0.5 sec to 1.5 sec, so that the transition time is greatly reduced and the cleaning can be performed favorably.

The discharge flow rate M of the rinse liquid discharged from the rinse nozzle is set to 400 ml/min to 1,000 ml/min, so that the number of the organic residues (the number of defects) can be reduced.

The rotational speed N of the substrate-to-be-cleaned is set to 150 rpm to 1,000 rpm, so that the number of the organic residues (the number of defects) can be reduced.

Pure water or 2-propanol is used as the rinse liquid, so that the rinse treatment can be performed favorably.

### BRIEF DESCRIPTION OF THE DRAWINGS

FIG. 1 is a constitutional diagram showing a single wafer cleaning apparatus of related art;

FIG. 2 is a plan view showing a relevant part of FIG. 1;

FIG. 3 is a constitutional diagram showing a single wafer cleaning apparatus according to an embodiment of the present invention;

FIG. 4A is a plan view showing a relevant part of FIG. 3 and FIG. 4B is a side view of FIG. 4A;

FIG. 5 is a graph in which the number of defects when using a rinse nozzle of related art is compared with the number of defects when using a rinse nozzle of a single wafer cleaning apparatus according to an embodiment of the present invention;

FIG. 6 is a graph showing a relation between transition time from an end of a discharge of a chemical liquid to a start of a discharge of a rinse liquid and the number of defects;

FIG. 7 is a graph showing a relation between a discharge flow rate of a rinse liquid and the number of defects in a single wafer cleaning apparatus according to an embodiment of the present invention; and

FIG. 8 is a graph showing a relation between a substrate rotational speed and the number of defects in a single wafer cleaning apparatus according to an embodiment of the present invention.

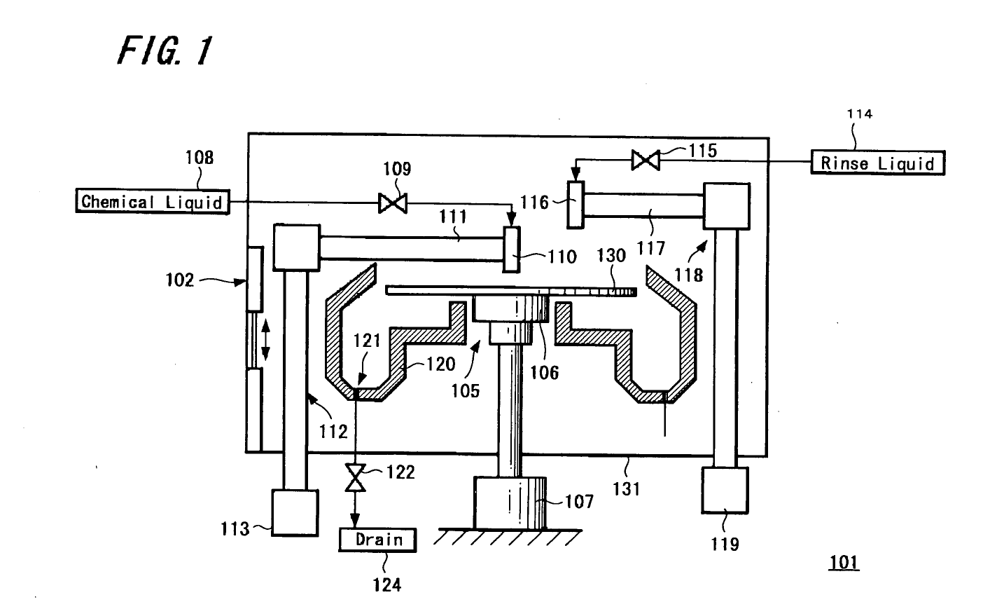

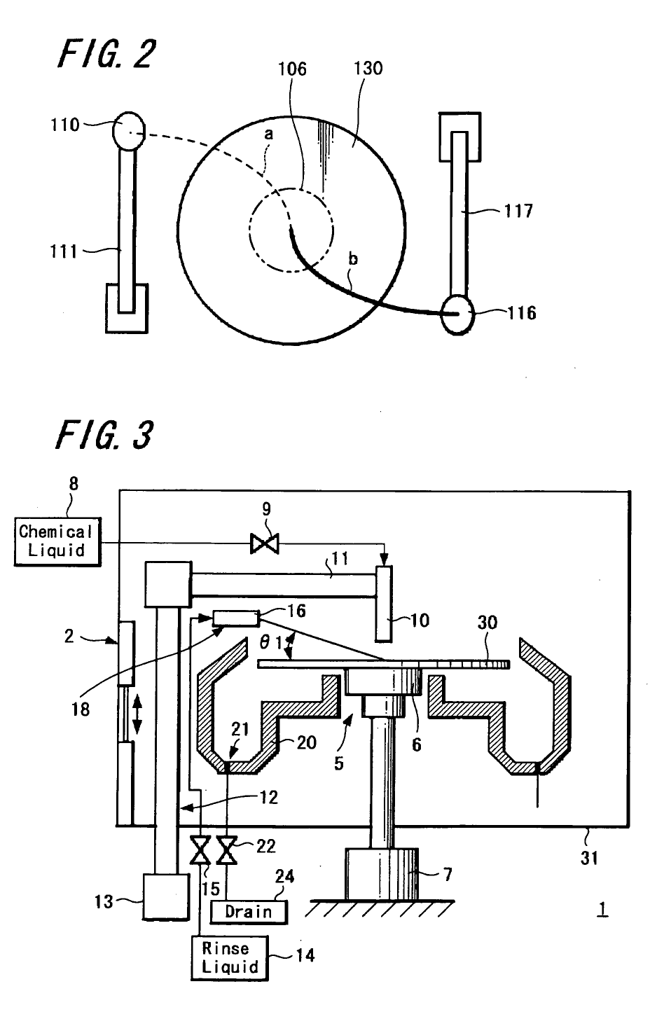

### DESCRIPTION OF THE PREFERRED EMBODIMENTS

Hereinafter, an embodiment of the present invention is explained with reference to the accompanied drawings.

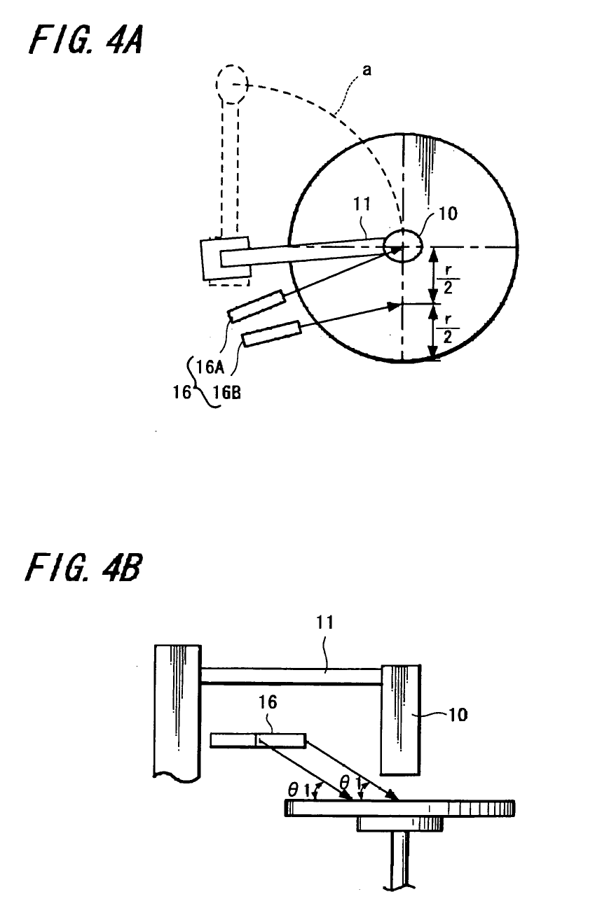

FIG. 3 is a schematic constitutional diagram showing an embodiment of a single wafer cleaning apparatus according to the present invention. FIG. 4A is a plan view and FIG. 4B is a side view of a relevant part of FIG. 3.

In a chamber 31 are provided a substrate holding device 5 to hold a substrate which should be cleaned, that is, a substrate-to-be-cleaned that is a silicon semiconductor substrate 30 in this embodiment, a chemical liquid supply device 12 having a chemical liquid nozzle which discharges a chemical liquid 8, and a rinse supply device 18 having a rinse nozzle 16 which discharges a rinse liquid 14. The substrate holding device 5 includes a vacuum chuck 6 for holding the semiconductor substrate 30 by vacuum adsorption and is rotatably operated by a motor 7. The chemical liquid supply device 12 includes a chemical liquid nozzle 10 provided on a tip of an arm 11 which can be turned by a motor 13 in a plane parallel with a semiconductor substrate plane. As shown in FIG. 4A, the chemical liquid nozzle 10 is made to move along a trajectory “a” shown with a broken line by the arm 11 which turns between a central part of the semiconductor substrate 30 and a standby position outside the semiconductor substrate 30 (refer to FIG. 4A).

The rinse liquid supply device 18 has a plurality, two in the present embodiment, of rinse nozzles 16 [16A, 16B]. Those two rinse nozzles 16 [16A, 16B] are disposed fixedly at a position not interfering with the movement of the chemical liquid nozzle 10, specifically, at a position outside the semiconductor substrate 30 which should be cleaned. The rinse nozzle 16A that is one of the two rinse nozzles 16 is disposed toward the central part of the semiconductor substrate 30 and the rinse nozzle 16B that is the other thereof is disposed toward a middle part in a radial direction of the semiconductor substrate 30 (refer to FIG. 4A). The rinse nozzle 16B can be disposed toward the middle part that is approximately ½ in the radial direction, for example. When semiconductor substrates of 8 inches and 10 inches are cleaned, the rinse nozzle 16B can be disposed toward a position 120 mm to 170 mm apart from the center of the substrate in the radial direction. Further, both the rinse nozzles 16 [16A, 16B] are disposed such that a discharge angle θ1 to the semiconductor substrate 30 may be 30° or more and 50° or less (refer to FIG. 4B). Furthermore, more than two rinse nozzles 16 may be provided depending on the efficiency of rinse treatment. Moreover, it is also possible to dispose only one rinse nozzle.

A cup 20 is disposed in the substrate holding device 5 to receive a drainage of the chemical liquid and the rinse liquid at the time of cleaning, and the drainage can be drawn off to a drain 24 from a drainage outlet 21 through a drainage valve 22. The chamber 31 is provided with a carrying in/out entrance 2 of the semiconductor substrate 30, which is capable of opening and closing. The chemical liquid 8 is supplied to the chemical liquid nozzle 10 through a chemical liquid valve 9. The rinse liquid 14 is supplied to the rinse nozzles 16 [16A, 16B] through a rinse liquid valve 15.

Next, an explanation is made with respect to a cleaning method in which a substrate is cleaned using a single wafer cleaning apparatus 1 according to the above-described embodiment. In this example, the above method is applied to cleaning of the semiconductor substrate 30 which has a treatment residue (polymer) generated on the substrate after a wiring pattern is formed on a silicon substrate, dry etching treatment is performed, and a resist mask is peeled off and removed.

First, the substrate 30 having the polymer, the residue or the like adhered thereto is carried into the chamber 31 from a carrying in/out entrance 2, and vacuum adsorption is performed to hold the substrate on the vacuum chuck 6 of the substrate holding device 5. The motor 13 is driven to turn the arm 11 from the standby position and to move the chemical liquid nozzle 10 to the central part over the substrate 30.

Next, while rotating the substrate 30 by the motor 7, the chemical liquid 8 is discharged from the chemical liquid nozzle 10 to remove the polymer residue on the semiconductor substrate 30. For example, an organic-based chemical liquid that contains an additive such as an organic solvent or an organic acid is used for the chemical liquid.

Then, the cleaning treatment using the chemical liquid 8 is ended. After finishing the treatment, concurrently with the chemical liquid nozzle 11 starting to turn to the standby position by means of the arm 11, the rinse treatment is performed by discharging the rinse liquid 14 on the rotating substrate 30 from the rinse nozzles 16 [16A, 16B]. The rinse liquid from one rinse nozzle 16A is supplied to the central part of the substrate 30, and the rinse liquid from the other rinse nozzle 16B is supplied to the middle part in the radial direction of the substrate 30. In this case, the switchover is performed such that the time T before starting the discharge of the rinse liquid 14 from the rinse nozzle 16 after finishing the discharge of the chemical liquid 8 from the chemical liquid nozzle 10 becomes a short time of 0.5 sec to 1.5 sec. A flow rate of 400 ml/min to 1,000 ml/min is set as the discharge flow rate M of this rinse liquid 14. A reason therefor is described later on. The rinse liquid is discharged uniformly from the rinse nozzles 16 [16A, 16B]. Furthermore, the rotational speed N of the substrate 30 at the time of rinse treatment is set to 150 rpm to 1,000 rpm. Pure water (cold water, warm water, or the like) is used as the rinse liquid 14. In addition, the rotational speed of the substrate 30 at the time of chemical liquid treatment described above is also set to 150 rpm to 1,000 rpm.

According to the substrate cleaning method using the single wafer cleaning apparatus of this embodiment, since the mutual interference of the nozzles due to the movement of the chemical liquid nozzle 10 and the rinse nozzles 16 is eliminated by fixedly disposing the rinse nozzles 16A and 16B at a position outside the substrate 30, the transition time from the chemical liquid treatment to the rinse treatment can be shortened. Specifically, the transition time T can be shortened to 0.5 sec to 1.5 sec. Therefore, the chemical liquid residue can be prevented from being dried and defects (polymer residues) on the substrate can be reduced. Further, with the optimum conditions of the flow rate of the rinse liquid, of the rotational speed of the substrate, and of the rinse liquid, the number of defects can further be reduced. The polymer and the chemical liquid residue adhered to the substrate can be cleaned and removed efficiently.

When the semiconductor substrates of 8 inches and 10 inches are cleaned, the rinse nozzle 16B is disposed toward a position 120 mm to 170 mm apart from the center of the substrate in the radial direction and both the rinse nozzles 16 [16A, 16B] are disposed such that the discharge angle θ1 to the semiconductor substrate 30 becomes 30° or more and 50° or less; when this range is exceeded, it is difficult to secure a spread of the rinse liquid for rinsing on the substrate and the efficiency of the rinse treatment is deteriorated.

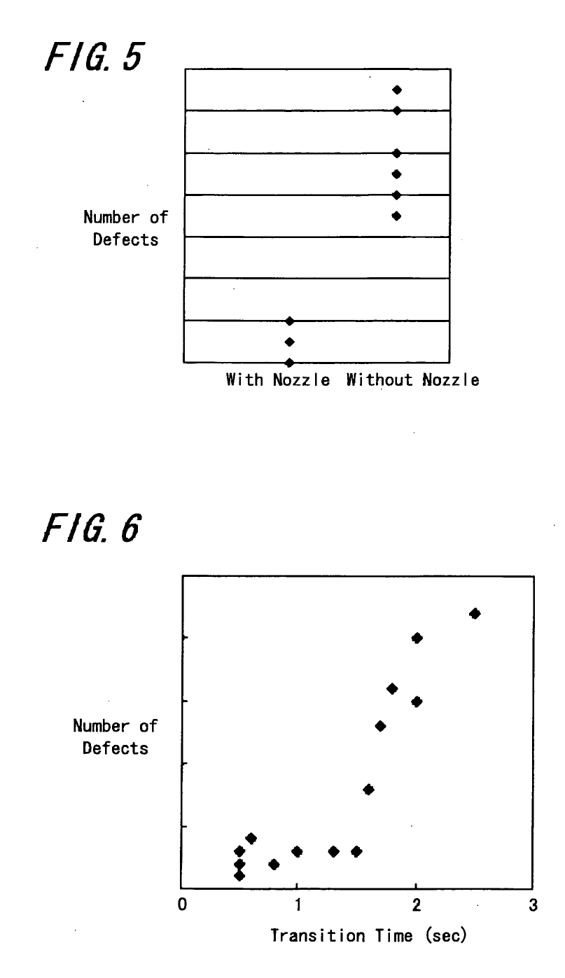

Next, a relation between the cleaning method according to this embodiment and the decrease in the number of defects is explained with reference to FIGS. 5 through 8. Hereinafter, a vertical axis shows a relative number.

FIG. 5 is a graph showing a relation between the number of defects after cleaned using the cleaning apparatus 101 of related art, which is denoted by “without nozzle”, and the number of defects after cleaned using the cleaning apparatus 1 according to this embodiment, which is denoted by “with nozzle”.

Although the number of defects are large in the case of the cleaning method of the related art, the number of defects can be reduced in the case of the cleaning method using the single wafer cleaning apparatus according to the present embodiment.

FIG. 6 is a graph showing a relation between the transition time from the end of the discharge of the chemical liquid to the start of the discharge of the rinse liquid and the number of defects.

In the single wafer cleaning apparatus 1 according to this embodiment, the number of defects is the least when the transition time from the end of the discharge of the chemical liquid to the start of the discharge of the rinse liquid is between 0.5 sec and 1.5 sec. When the transition time exceeds 1.5 sec, the number of defects increases. When the transition time is shorter than 0.5 sec, it is difficult to start the discharge of the rinse liquid after finishing the discharge of the chemical liquid. When the transition time from the end of the discharge of the chemical liquid to the start of the discharge of the rinse liquid is 0.5 sec or more and 1.5 sec or less, the chemical liquid residue on the substrate is not dried and the effectiveness of the cleaning can be improved. The number of defects on the substrate can be decreased, and the improvement in the yield ratio can be obtained.

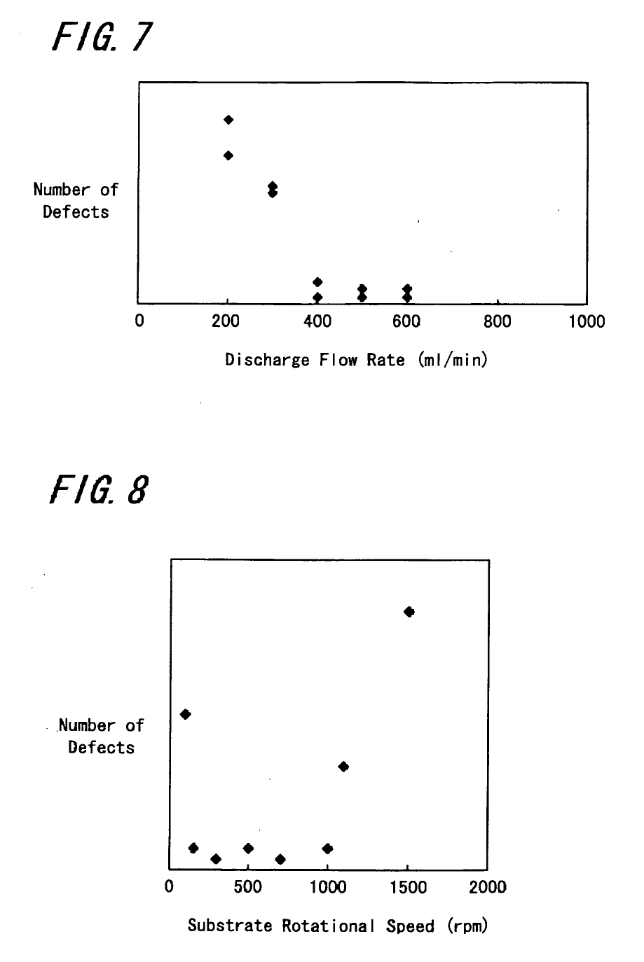

FIG. 7 is a graph showing a relation between the discharge flow rate of the rinse liquid and the number of defects in the single wafer cleaning apparatus according to the present embodiment.

When the discharge flow rate of the rinse liquid uniformly discharged from the rinse nozzles 16 [16A, 16B] of the single wafer cleaning apparatus 1 according to this embodiment is within the range of 400 ml/min to 1,000 ml/min, the number of defects can be decreased to a minimum. When the discharge flow rate of the rinse liquid is less than 400 ml/min, the number of defects increases. When the discharge flow rate is more than 1,000 ml/min, the cost of raw materials increases due to a large amount of consumption of rinse liquid. It is desirable that a treatment time of the rinse treatment is set to 60 sec to 90 sec in order to reliably complete the cleaning.

FIG. 8 is a graph showing a relation between the rotational speed of the substrate and the number of defects in the single wafer cleaning apparatus according to this embodiment.

The substrate 30 is held by the vacuum chuck of the substrate holding device in the single wafer cleaning apparatus 1 according to this embodiment and is rotated by the motor 7 of the rotation device. The substrate 30 continuously rotates from the start of the discharge of the chemical liquid from the chemical liquid nozzle 10 until the end of the discharge of the rinse liquid from the rinse nozzles 16.

When the rotational speed of the substrate is within the range of 150 rpm to 1,000 rpm, the number of defects can be most reduced. Specifically, the rinse treatment can be performed reliably. When the rotational speed of the substrate becomes less than 150 rpm, the number of defects increases. Moreover, when the rotational speed of the substrate becomes faster than 1,000 rpm, an increase in the number of defects becomes conspicuous.

It should be noted that the rinse liquid is not limited to pure water but a similar effectiveness can be obtained when 2-propanol (IPA), for example, is used and after that the rinse treatment is performed by using pure water.

As described above, a polymer which is a treatment residue at the time of dry etching on a substrate can be cleaned and removed efficiently by using the single wafer cleaning method and the cleaning apparatus thereof according to this embodiment. Therefore, when the present invention is applied to cleaning of a semiconductor substrate on producing a semiconductor device, for example, the cleaning thereof can be performed reliably and a cleaning yield ratio can be improved. As a result, a production yield of the semiconductor device which is a final manufactured product can be improved and the reliability thereof can also be improved.

In the above-described embodiment, the cleaning method of the present invention is applied to the cleaning of the semiconductor substrate, however, this cleaning method can also be applied to cleaning of a glass substrate for a liquid crystal display device, a glass substrate for a photomask, a substrate for an optical disk, and the like.

It should be understood by those skilled in the art that various modifications, combinations, sub-combinations and alterations may occur depending on design requirements and other factors insofar as they are within the scope of the appended claims or the equivalents thereof.

1. A single wafer cleaning method in which a substrate-to-be-cleaned is cleaned by a chemical liquid and a rinse liquid while being rotated, comprising the steps of:
performing chemical liquid treatment by moving a chemical liquid nozzle over said substrate-to-be-cleaned; and
subsequently performing rinse treatment on said substrate-to-be-cleaned by discharging the rinse liquid from a rinse nozzle disposed fixedly at a position not interfering with the movement of said chemical liquid nozzle.

2. A single wafer cleaning method according to claim 1,
wherein a plurality of said rinse nozzles are provided,
the rinse liquid from at least one rinse nozzle among said plurality of rinse nozzles is discharged to a central part of said substrate-to-be-cleaned, and
the rinse liquid from the other rinse nozzles is discharged to a middle part in a radial direction of said substrate-to-be-cleaned.

3. A single wafer cleaning method according to claim 1,
wherein a transition time T from the chemical liquid treatment to the rinse treatment of said substrate-to-be-cleaned is 0.5 sec≦T≦1.5 sec.

4. A single wafer cleaning method according to claim 1,
wherein a discharge flow rate M of the rinse liquid discharged from said rinse nozzle is 400 ml/min≦M≦1,000 ml/min.

5. A single wafer cleaning method according to claim 1,
wherein a rotational speed N of said substrate-to-be-cleaned is 150 rpm≦N≦1,000 rpm.

6. A single wafer cleaning method according to claim 1,
wherein pure water or 2-propanol is used as said rinse liquid.

7. A single wafer cleaning apparatus in which a substrate-to-be-cleaned is cleaned by a chemical liquid and a rinse liquid while being rotated, comprising:
substrate holding means to hold and rotate said substrate-to-be-cleaned;
a chemical liquid nozzle which moves between a standby position and a central part over said substrate-to-be-cleaned; and
a rinse nozzle disposed fixedly at a position not interfering with the movement of said chemical liquid nozzle.

8. A single wafer cleaning apparatus according to claim 7,
wherein a plurality of said rinse nozzles are provided;
at least one rinse nozzle among said plurality of rinse nozzles is disposed toward the central part of said substrate-to-be-cleaned; and
the other rinse nozzles are disposed toward a middle part in a radial direction of said substrate-to-be-cleaned.

9. A single wafer cleaning apparatus according to claim 7,
wherein a transition time T from chemical liquid treatment to rinse treatment of said substrate-to-be-cleaned is 0.5 sec≦T≦1.5 sec.

10. A single wafer cleaning apparatus according to claim 7,
wherein a discharge flow rate M of the rinse liquid discharged from said rinse nozzle is 400 ml/min≦M≦1,000 ml/min.

11. A single wafer cleaning apparatus according to claim 7,
wherein a rotational speed N of said substrate-to-be-cleaned is 150 rpm≦N≦1,000 rpm.

12. A single wafer cleaning apparatus according to claim 7,
wherein said rinse liquid is pure water or 2-propanol.
